(19) United States
(12) Patent Application Publication
(10) Pub. No.: US 2021/0098940 A1
(43) Pub. Date: Apr. 1, 2021

(54) ELECTROMAGNETIC MAGNETIC INTERFERENCE (EMI) ABSORBER FOR AN ELECTRONIC CONNECTOR

(71) Applicant: Arista Networks, Inc., Santa Clara, CA (US)

(72) Inventors: Richard Hibbs, Santa Clara, CA (US); Robert Wilcox, Saratoga, CA (US); Tiong Khai Soo, Milpitas, CA (US)

(21) Appl. No.: 16/829,902

(22) Filed: Mar. 25, 2020

Related U.S. Application Data
(60) Provisional application No. 62/909,184, filed on Oct. 1, 2019.

(51) Int. Cl. H01R 13/6581; H01R 12/71; H01R 13/502

(52) U.S. Cl. CPC H01R 13/6581; H01R 13/502; H01R 12/71

(57) ABSTRACT

A system includes an electronic connector configured to be coupled to a connector module and an electromagnetic interference (EMI) absorber proximate to and at least partially surrounding the electronic connector. The EMI absorber may be positioned as close as possible to the electronic connector and may be attached to the electronic connector. This positioning of the EMI absorber at least partially absorbs EMI present at the electronic connector and thereby reduces the noise on electronic signals being communicated on conductors of the electronic connector as well as reducing overall radiated emissions from an electronic system including the electronic connector.

### CROSS-REFERENCE TO RELATED APPLICATION

The present application claims the benefit and priority under 35 U.S.C. 119(e) of U.S. Provisional Application No. 62/909,184, filed Oct. 1, 2019, entitled “Electromagnetic Magnetic Interference (EMI) Absorber for an Electronic Connector.” The entire contents of this provisional application are incorporated herein by reference for all purposes.

### BACKGROUND

The present disclosure relates to generally to electronic connectors, and more particularly to improving the performance of electronic connectors in the presence of electromagnetic interference (EMI).

A variety of different types of electronic connection systems are utilized in different types of electronic devices. A typical electronic connection system includes a plug or module that is inserted into a port of an electronic connector. This connection between the module and the port of the electronic connector may be pluggable and removable, may require a tool for assembly and removal, or may be a permanent electrical connection between the module and port of the electronic connector. Each of the module and port of the electronic connector includes conductive elements that are coupled together to carry or propagate electronic signals being communicated between electronic circuitry in the module and electronic circuitry coupled to the electronic connector. The electronic connector may be present in an environment including EMI, which is typically generated at least in part by electronic components present in this environment that are proximate to the electronic connector, including the electronic circuitry in the module. This EMI may introduce noise on the electronic signals propagating on the conductive elements of the electronic connector, resulting in improper or degraded performance of the electronic circuitry in the module coupled to the electronic connector.

In general, it would be desirable to improve the performance of electronic connection systems in the presence of EMI.

The following detailed description and accompanying drawings provide a better understanding of the nature and advantages of the present disclosure.

### BRIEF DESCRIPTION OF THE DRAWINGS

FIG. 1 illustrates a connection system including an EMI absorber for an electronic connector according to one embodiment of the present disclosure.

FIG. 2 illustrates a connector system including an EMI absorber attached to an electronic connector on a printed circuit board according to another embodiment.

FIGS. 3A and 3B illustrate a quad small form-factor pluggable double density (QSFP-DD) connector system including an EMI absorber according to another embodiment.

FIGS. 4A and 4B illustrate an octal small format pluggable (OSFP) connector system including an EMI absorber according to another embodiment.

FIGS. 5A and 5B illustrate a (2×N) OSFP connector system including EMI absorbers according to another embodiment.

FIGS. 6A-6C illustrate in more detail an OSFP connector system including an EMI absorber according to another embodiment.

FIGS. 7A-7D illustrate in more detail a cage portion of a QSFP-DD connector system including an EMI absorber according to another embodiment.

FIGS. 8A and 8B illustrate in more detail a cage portion of a (1×N) QSFP-DD connector system including EMI absorbers according to another embodiment.

FIG. 9 is a functional block diagram of a network element including a connector system according to another embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

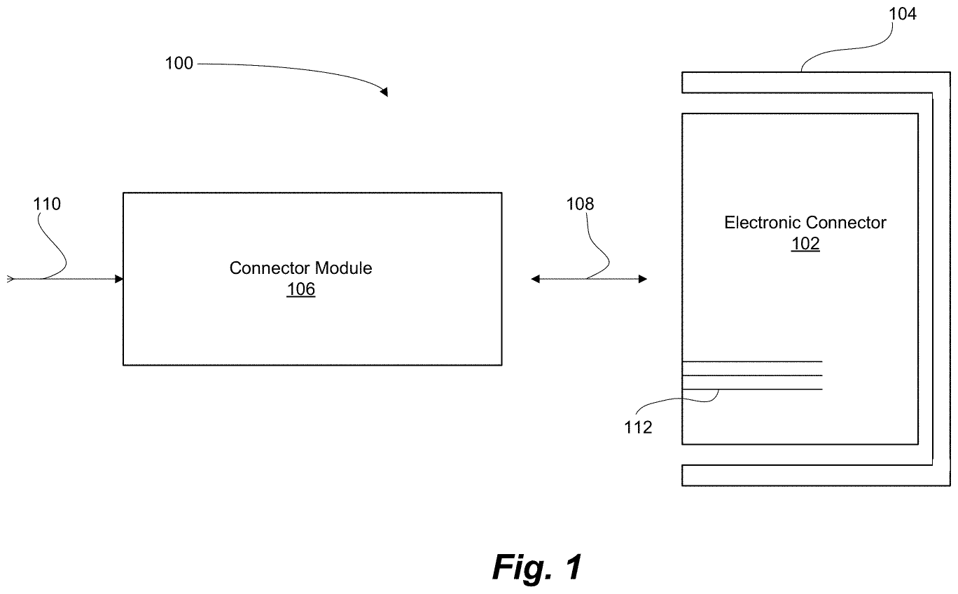

FIG. 1 illustrates an electronic connection system 100 including an electronic connector 102 having an EMI absorber 104 proximate to and at least partially surrounding the electronic connector according to one embodiment of the present disclosure. The connection system 100 includes a connector module 106 that may be removably or permanently coupled to the electronic connector 102, as illustrated through the arrow 108 in FIG. 1. The connector module 106 communicates electrical signals through the electronic connector 102 to electronic circuitry (not shown) coupled to the electronic connector, and also communicates electrical or optical signals 110 to electronic circuitry (not shown) coupled to the connector module.

The electronic connector 102 includes conductive elements 112 that are typically contained within a plastic or other material forming a housing or package of the electronic connector. A package formed from such a material does not provide protection against EMI present at the electronic connector 102. This EMI may be generated by components in the connector module 106, by other electronic components contained in the environment of the electronic connector 102, or by other electronic components radiating EMI into the environment of the electronic connector. Because the package of the electronic connector 102 does not provide protection against EMI present at the electronic connector, neither shielding nor absorption, signals present on the conductive elements 112 are susceptible to noise being introduced to them caused by this EMI.

The EMI absorber 104 is proximate to and at least partially surrounding the electronic connector 102 to absorb EMI present at the electronic connector 102 and thereby reduce noise on the signals on the conductive elements 112 of the electronic connector. This positioning of the EMI absorber 104 also reduces overall radiated emissions from an electronic system including the electronic connector 102. The EMI absorber 104 may be placed, either fixedly or removably, as close as possible to the electronic connector 102. This placement of the EMI absorber 104 may be limited by the physical structure of the electronic connector 102, as well as by other components in electronic connection system 100. Thus, in some embodiments the EMI absorber 104 may be placed directly on or attached to the electronic connector 102 while in other embodiments the EMI absorber may be placed proximate, in some embodiments as close as possible, to the electronic connector 102. In one embodiment, the EMI absorber 104 is physically attached to the electronic connector 102 through a suitable layer of adhesive material. The EMI absorber 104 is made of or includes a suitable material that will absorb EMI or electromagnetic radiation in a desired frequency range, as will be appreciated by those skilled in the art.

In some embodiments of the present disclosure, the EMI absorber 104 is “proximate” the electronic connector 102, which means the EMI absorber may be in direct contact with electronic connector or as close as possible to the electronic connector given constraints arising from the structure of the connection system 100 around the electronic connector. For example, where the connection system 100 includes a housing or cage (not shown in FIG. 1), which in prior connection systems may function, in part, to provide EMI shielding or absorption for the electronic connector positioned within the housing or cage, the EMI absorber is positioned closer to the electronic connector than is the housing or cage. This positioning of the EMI absorber 104 nearer the electronic connector than the housing or cage provides improved absorption of EMI at the electronic connector and accordingly reduces levels of noise on signals communicated on the conductive elements of the electronic connector.

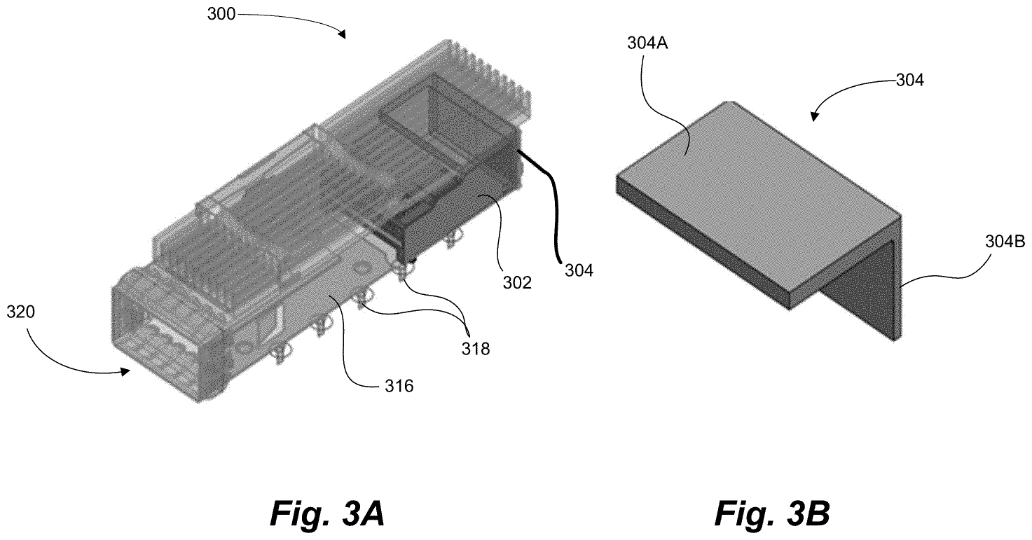

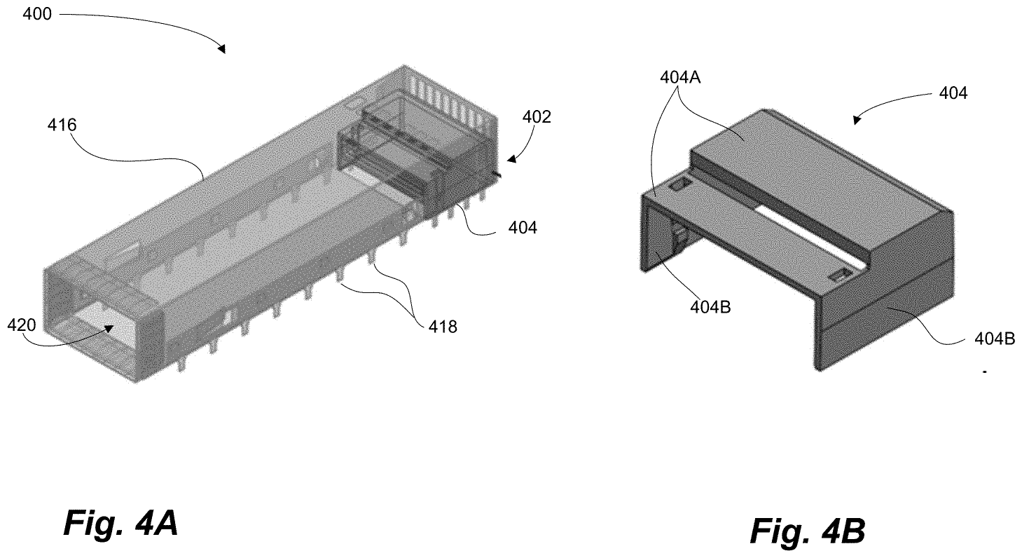

The shape or structure of the electronic connector 102 varies in different embodiments, and depends on the particular type of electronic connector in the connection system 100. The electronic connector 102 may be, for example, a surface mount technology (SMT) connector, as will be described below with reference to the embodiments of FIGS. 3-8. Embodiments of the present disclosure are not limited to EMI absorbers for SMT connectors, however, and include EMI absorbers positioned proximate to other types of electronic connectors. In some embodiments, for example, the electronic connector 102 includes a plurality of surfaces, and the EMI absorber 104 is attached or positioned to at least partially cover at least some of these plurality of surfaces. One such embodiment will be described in more detail below with reference to FIG. 3B. In other embodiments, the electronic connector 102 includes a top surface and a plurality of side surfaces, and the EMI absorber 104 at least partially covers the top surface and at least one of the plurality of side surfaces. One such embodiment will be described in more detail below with reference to FIG. 4B.

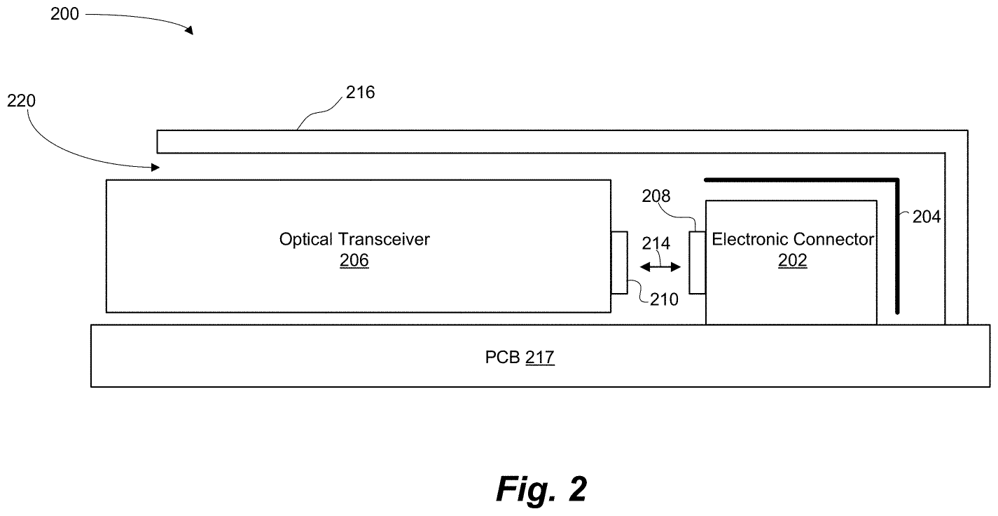

FIG. 2 illustrates an electronic connection system 200 including an electronic connector 202 and an EMI absorber 204 positioned proximate to the electronic connector according to another embodiment. The electronic connector 202 may be an SMT connector, a through hole connector, or any other type of electronic connector suitable for the application of the electronic connection system 200. A connector module 206, which is an optical transceiver in the example embodiment of FIG. 2, may be removably or permanently coupled to the electronic connector 102. The electronic connector 202 includes a coupling port 208 that is configured to receive a connection port or connector 210 of an optical transceiver 212. The connector 210 of the optical transceiver 206 may be removably inserted into the coupling port 208 of the connector 202, as represented through the arrow 214 in FIG. 2. A connector housing or cage 216 attaches to a PCB 217 to which the electronic connector 202 is attached, and the connector cage may also attach to the electronic connector. The connector cage 216 includes an input or cage port 220 that receives the optical transceiver 206 and guides the connector 210 of the optical transceiver into the coupling port 208 of the electronic connector 202 as the optical transceiver is inserted into the cage port. The EMI absorber 204 at least partially covers the electronic connector 202 and is positioned between the electronic connector 202 and the connector cage 216.

As described above with reference to the electronic connection system 100 of FIG. 1, the EMI absorber 204 is positioned proximate to the electronic connector 202 and may be physically attached to the electronic connector. In some embodiments, the EMI absorber 204 may be attached to the electronic connector 202 by a layer of adhesive material or other suitable attachment mechanism to attach the EMI absorber 206 to the electronic connector 202. In one embodiment, the electronic connector 202 includes a top surface and a plurality of side surfaces over the PCB 217, and the EMI absorber 204 at least partially covers the top surface and one of the side surfaces, as illustrated in the example embodiment of FIG. 2. In another embodiment, the electronic connector 202 includes a top surface and a plurality of side surfaces over the PCB 217 and the EMI absorber 204 at least partially covers the top surface and the plurality of side surfaces, as will be described in more detail below with reference to the example embodiment of FIG. 3B.

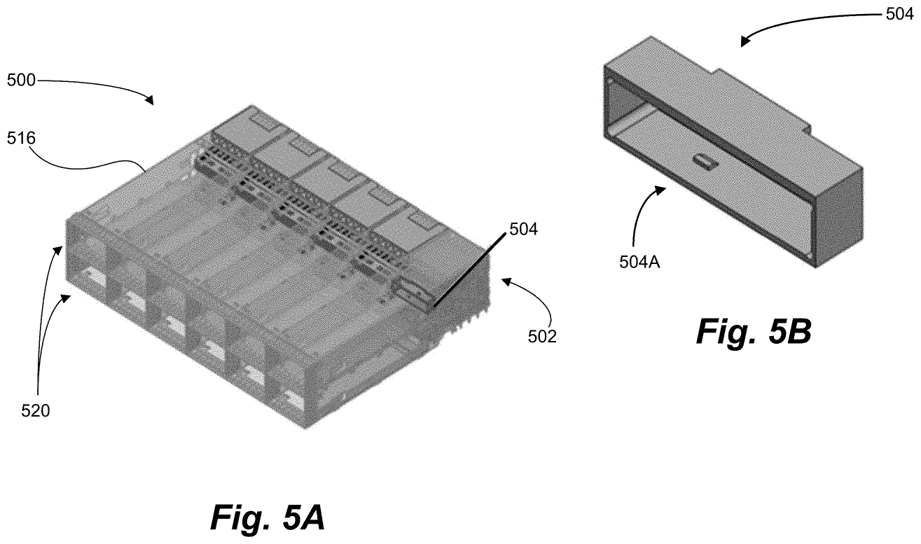

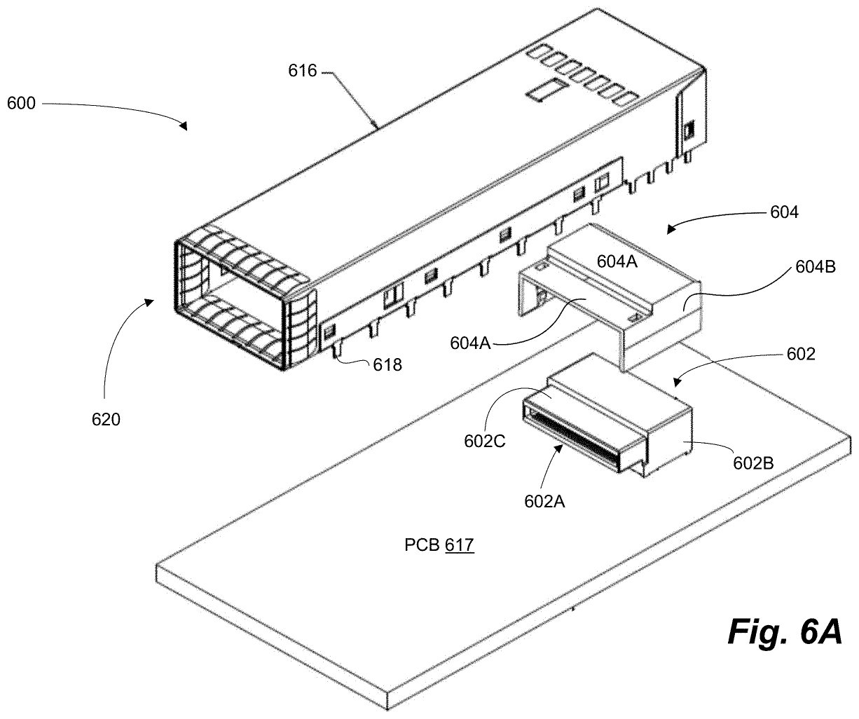

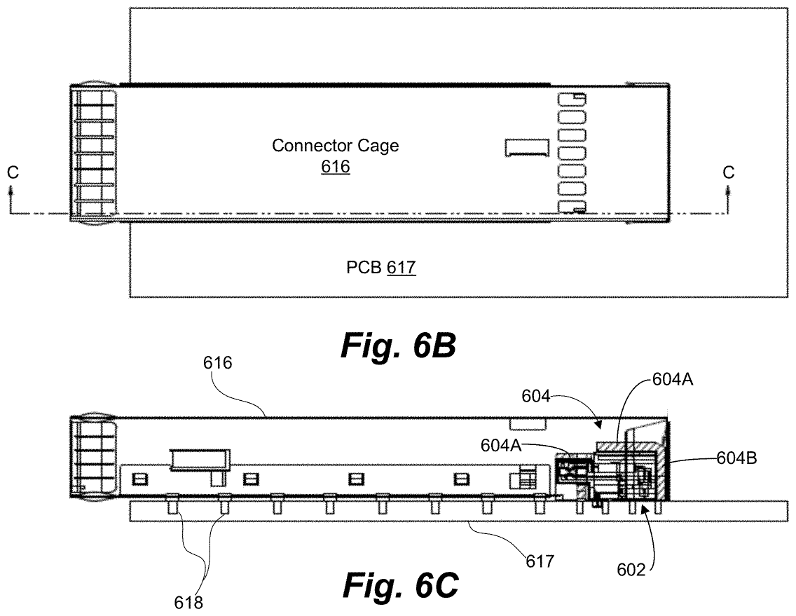

In a further embodiment, the electronic connector 202 includes a base attached to the PCB 217 and a coupling projection that includes the coupling port of the electronic connector, and the EMI absorber 204 has a structure that slides onto and surrounds at least a portion of the coupling projection, as will be described in more detail below with reference to the example embodiments of FIGS. 5B and 6A. In yet another embodiment of the electronic connection system 200, the electronic connector 202 is an SMT connector and the electronic connector 202 and connector cage 216 form an Octal Small Formfactor Pluggable (OSFP) connector system. The electronic connector 202 and connector cage 216 form a Quad Small Form Factor Pluggable Double Density (QSFP-DD) connector system in another embodiment of the electronic connection system 200, as will be described in more detail below with reference to FIGS. 3A-3B, 7A-7D and 8A-8B.

FIG. 3A illustrates a QSFP-DD connector system 300 including an electronic connector 302, which is an SMT connector in this embodiment, and an EMI absorber 304 that provides EMI protection for the SM connector. FIG. 3B illustrates an enlarged view of the EMI absorber 304 of FIG. 3A according to another embodiment of the present disclosure. The QSFP-DD connector system 300 includes the SMT connector 302 that is configured to be attached to a PCB (not shown in FIGS. 3A and 3B) and a connector cage 316 including cage pins 318 configured to also attach to the connector cage to the PCB. The connector cage 316 also includes a back portion that covers the SMT connector 302 and a cage port 320 that is configured to receive an optical transceiver (not shown in FIGS. 3A and 3B) and to guide a connector of the optical transceiver into a coupling port of the SMT connector 302 as the optical transceiver is inserted into the cage port of the connector cage. The optical transceiver may, for example, be a 400G optical transceiver.

The view of the QSFP-DD connector system 300 of FIG. 3A is a see-through perspective view of the connector system and illustrates the EMI absorber 304 in position on the SMT connector 302 at the back portion of the connector cage 316. FIG. 3B is an enlarged perspective view of the EMI absorber 304 showing that in this embodiment the EMI absorber covers all or a portion of a top surface of the SMT connector 302 and a portion of one of the sides of the SMT connector. More specifically, in the illustrated embodiment, the EMI absorber 304 includes a top cover 304A joined or attached at one end to a side cover 304B extending orthogonal to the top cover as seen in FIG. 3B. When in position proximate to the SMT connector 302, the top cover 304A covers at least a portion of a top surface of the SMT connector and the side cover 304B covers at least a portion of a side surface of the SMT connector. The EMI absorber 304 may be physically attached to a back portion of the connector cage 316 proximate to the SMT connector 302 or may be physically attached to the SMT connector in this embodiment. In one embodiment, the EMI absorber 304 is attached to the connector cage 316 through a layer of a suitable adhesive material, which is not expressly illustrated in FIGS. 3A and 3B.

FIG. 4A illustrates an OSFP connector system 400 including an electronic connector 402, which is an SMT connector, protected by an EMI absorber 404 according to another embodiment. FIG. 4B illustrates in more detail the EMI absorber 404 of FIG. 4A. The OSFP connector system 400 includes the SMT connector 402 that is configured to be attached to a PCB (not shown in FIGS. 4A and 4B) and a connector cage 416 including cage pins 418 configured to also attach the connector cage to the PCB. The connector cage 416 also includes a back portion that covers the SMT connector 402 and a cage port 420 that is configured to receive an optical transceiver (not shown) and to guide a connector of the optical transceiver into a coupling port of the SMT connector 402 as the optical transceiver is inserted into the cage port of the connector cage. The optical transceiver may, for example, be a 400G optical transceiver.

The view of the OSFP connector system 400 of FIG. 4A is once again a see-through perspective view of the connector system and illustrates the EMI absorber 404 in position on the SMT connector 402 at the back portion of the connector cage 416. FIG. 4B is an enlarged perspective view of the EMI absorber 404 showing that in this embodiment the EMI absorber includes a top surface or cover 404A and multiple side surfaces or side walls 404B attached to the top cover. The top cover 404A includes a first higher segment and a second lower segment arranged so that when the EMI absorber 404 is in position proximate to the SMT connector 402, each of these segments covers a corresponding segment of a top surface of the SMT connector. Similarly, the side walls 404B are arranged to cover corresponding side surfaces of the SMT connector 402, including a back-side surface (not shown) of the SMT connector.

In the embodiment of FIGS. 4A and 4B, the EMI absorber 404 may be either physically attached to the SMT connector 402 or placed over the SMT connector so that the top cover 404A and side walls 404B cover corresponding portions of the SMT connector as described above. Alternatively, the EMI absorber 404 may be physically attached to a back portion of the connector cage 416 proximate to the SMT connector 402. In the OSFP connector system 400, the EMI absorber 404 is positioned between the connector cage 416 and the SMT connector 402, with the connector cage securing the EMI absorber in position over or on the SMT connector when the connector system is assembled as shown in the see through perspective view of FIG. 4A.

FIGS. 5A and 5B illustrate a (2×N) OSFP connector system 500 including SMT connectors 502 protected by EMI absorbers 504 including an aperture 504A configured to fit over a coupling sleeve or projection (not shown) of the SMT connectors according to another embodiment. The OSFP connector 500 system includes (2×N) individual OSFP connectors, where N equals 6 in the example embodiment of FIG. 5A. The OSFP connector system 500 as illustrated in the see-through perspective view of FIG. 5A includes individual SMT connectors 502 at the back of each of several individual OSFP connector cages 516. Each OSFP connector cage 516 includes a cage port 520 configured to receive an optical transceiver (not shown) and to guide a connector of the optical transceiver to couple with a coupling port (not shown) of the corresponding SMT connector 502. There are (2×N) OSFP connector cages 516 and thus (2×N) SMT connectors 502 at the back of these connector cages in the example embodiment of FIG. 5A.

An individual EMI absorber 504 is attached to each SMT connector 502, with only one EMI absorber being illustrated in FIG. 5A. FIG. 5B is an enlarged view showing in more detail one of the EMI absorbers 504 contained on the SMT connectors 502 in the OSFP connector system 500. Each EMI absorber 504 includes four walls coupled together to form the aperture 504A through the interiors of these walls. The aperture 504A is formed to fit over a coupling projection (not shown) of a corresponding one of the SMT connectors 502. The shape of the coupling projection may vary in different embodiments, and thus the shape of the aperture 504A will accordingly vary to allow the EMI absorber 504 to fit over or slide onto the coupling projection. In general, the EMI absorber 504 has at least one planar surface or wall coupled to form a loop and define the aperture 504A on the interior of this loop. The shape of the loop is determined by the shape of the coupling projection of the electronic connector. The EMI absorber 504 having the aperture 504A illustrates that EMI absorbers according to embodiments of the present disclosure may have a variety of different structures. The specific connector system into which the EMI absorber is being utilized determines the specific structure of the EMI absorber.

FIGS. 6A-6C illustrate in more detail an OSFP connector system 600 including an SMT connector 602 and an EMI absorber 604 according to yet another embodiment. FIG. 6A is an exploded perspective view of the OSFP connector system 600, which includes the EMI absorber 604 formed to fit over the SMT connector 602 that is attached to a printed circuit board (PCB) 617. A connector cage 616 is placed over the EMI absorber 604 and SMT connector 602 and attaches to the PCB 617 with the EMI absorber secured in position proximate to the SMT connector. The connector cage 616 includes pins 618 to attach the connector cage to the PCB 617 and an input or cage port 620 that receives an optical transceiver (not shown) and guides a connector of the optical transceiver into a coupling port 602A of the SMT connector 602. The EMI absorber 604 may be attached to the SMT connector 602 or to the connector cage 616, such as through a suitable adhesive. The EMI absorber 604 may also be formed from a suitable pliable material and sized to clip onto the SMT connector 602 in some embodiments. The SMT connector 602 includes a base 602B having a coupling projection 602C extending from a side of the base. The coupling projection 602C includes the coupling port 602A that receives the connector of the optical transceiver when the optical transceiver is inserted into the port 620 of the connector cage 616. In the embodiment of FIGS. 6A-6C, the EMI absorber 604 includes a top cover 604A having a higher segment and a lower segment, and side walls 604B. The EMI absorber 604 is formed to fit over and cover at least some portions of the SMT connector 602. More specifically, when the EMI absorber 604 is placed in position over the SMT connector 602, the higher segment of the top cover 604A covers the upper surface of the base 602B, the lower segment covers the upper surface of the coupling projection 602C, and the sides walls 604B cover corresponding side surfaces of the base and coupling projection of the SMT connector.

FIG. 6B is a top view of the OSFP connector system 600 showing the connector cage 616 in position on the PCB 617. FIG. 6C a cross-sectional side view of the OSFP connector system 600 taken along the line CC of FIG. 6B. FIG. 6C illustrates the EMI absorber 604 in position on the SMT connector 602 at the back portion of the connector cage 616. This view illustrates a back-side wall 604B of the EMI absorber 604 covers a back surface of the base 602B of the SMT connector 602 in addition to the side surfaces of the base and coupling projection 602C.

In another embodiment, the EMI absorber 504 of FIG. 5B could be used to provide EMI protection for a connector system including one or more of the SMT connectors 602 of FIG. 6A. In such an embodiment, the EMI absorber 504 in FIG. 5B is sized to slide onto the coupling projection 602C of the SMT connector 602 and surrounds this coupling projection when in position thereon. This embodiment may be used, for example, where the physical structure of the connector system does not allow, perhaps due to space constraints, the EMI absorber 604 to be utilized to provide EMI protection for SMT connectors 602 in the connector system.

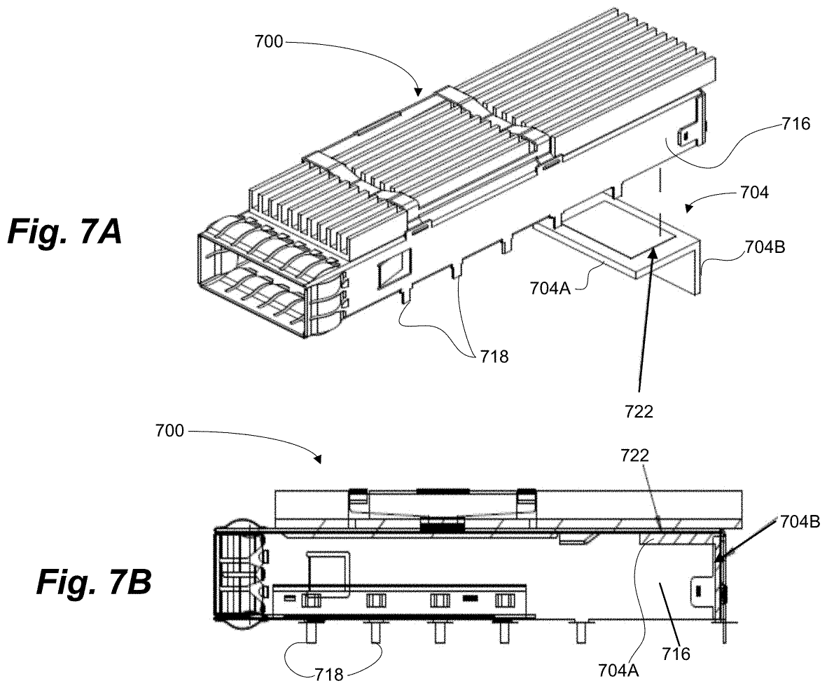

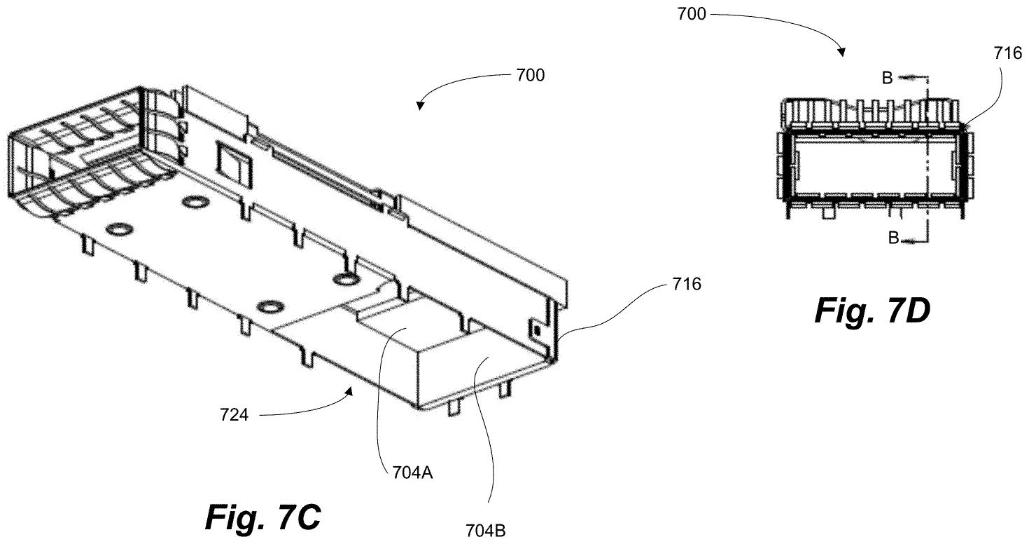

FIGS. 7A-7D illustrate in more detail a portion of a QSFP-DD connector system 700 including an EMI absorber 704 configured to attach to a connector cage 716 according to another embodiment. The connector cage 716 includes mounting projections or pins 718 that are used in attaching the connector cage to a PCB (not shown) or other substrate. FIG. 7A is a perspective view of the QSFP-DD connector system 700 and FIG. 7B is a cross-sectional side view showing the attachment of the EMI absorber 704 at a back portion of the connector cage 716 through a layer of adhesive 722. FIG. 7C is a bottom perspective view of the connector system 700 showing a chamber 724 at a back portion of the connector cage 716 in which the EMI absorber 704 is attached as shown. More specifically, as seen in FIG. 7A, the EMI absorber 704 includes a top cover or wall 704A and a side cover or wall 704B attached at one end of the top wall and extending orthogonal to a plane in which the top wall extends. The layer of adhesive 722 (not shown in FIG. 7C) is on an upper surface of the top wall 704A. The EMI absorber 704 is inserted into the chamber 724 to attach the top wall 704A to an upper wall (not shown) of the chamber and thereby secure the EMI absorber to the connector cage 716. After attaching the EMI absorber 704 to the connector cage 716 as shown in FIG. 7C, the connector cage is then attached to a PCB (not shown) including an electronic connector (not shown) such that the EMI absorber is positioned over the electronic connector to absorb EMI at the electronic connector. FIG. 7D is side view of the connector system 700 looking into a cage port of the connector cage 716. The cross-sectional view of FIG. 7B corresponds to the cross-sectional view of the connector cage 716 taken along the line BB of FIG. 7D.

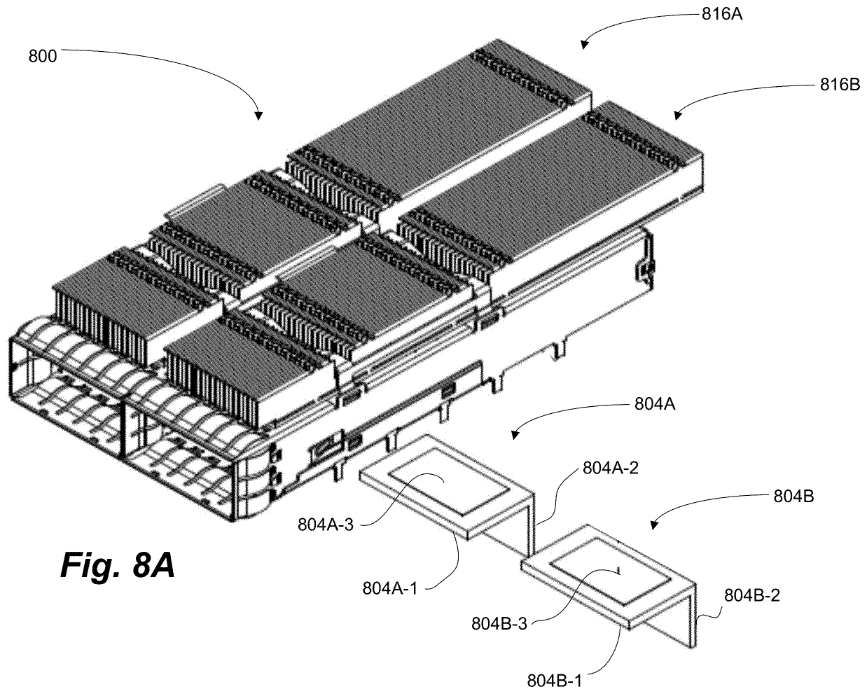

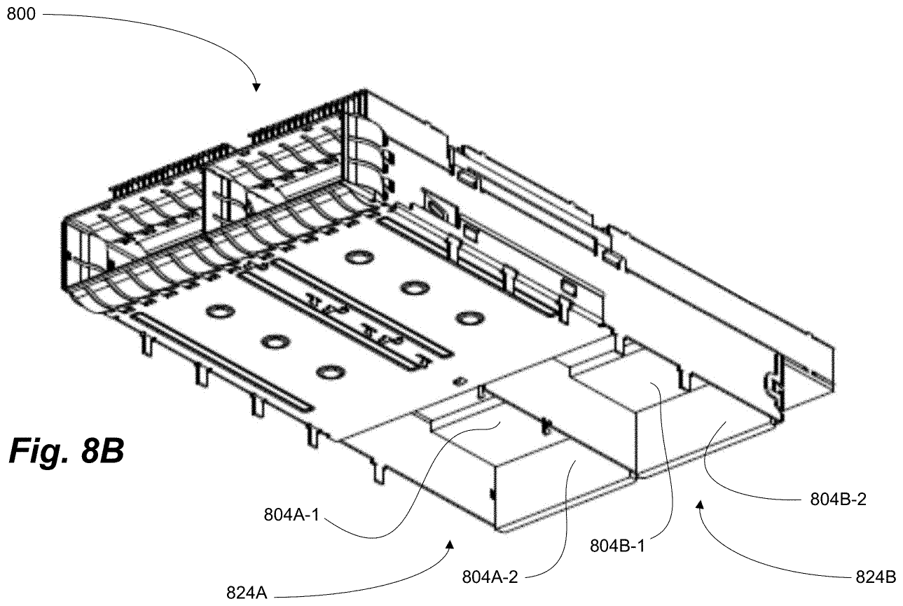

FIGS. 8A and 8B illustrate in more detail a portion of a (1×N) QSFP-DD connector system 800 including two EMI absorbers 804A, 804B and two integrated connector cages 816A, 816B according to another embodiment. FIG. 8A is a perspective view of the connector system 800 showing each EMI absorber 804A, 804B positioned under the corresponding connector cage 816A, 816B to which the EMI absorber is to be attached. This embodiment is similar to that of FIGS. 7A and 7B except that the connector system 800 includes two cage portions with an EMI absorber 804A, 804B positioned in respective chambers 824A, 824B of these two cage portions, as shown in FIG. 8B. Each EMI absorber 804A, 804B includes a top wall 804A-1, 804B-1 and a side wall 804A-2, 804B-2 attached at one end of the corresponding top wall and extending orthogonal to plane in which the top wall extends. A layer of adhesive 804A-3, 804B-3 is on upper surfaces of the respective top walls 804A-1, 804B-1. Each EMI absorber 804A, 804B is inserted into the corresponding chamber 824A, 824B to attach the top wall 804A-1, 804B-1 to an upper wall (not shown) of the chamber and thereby secure the EMI absorber to the corresponding connector cage 816A, 816B. After attaching the EMI absorbers 804A, 804B to the two integrated connector cages 816A, 816B as shown in FIG. 8B, the integrated connector cages are then attached to a PCB (not shown) including electronic connectors (not shown) such that each of the EMI absorbers is positioned over a corresponding electronic connector to absorb EMI at the electronic connector.

Embodiments of EMI absorbers according to the present disclosure, such as the example EMI absorbers 104, 204, 304, 404, 504, 604, 704 and 804 may be formed from a variety of different types of structures, as will be appreciated by those skilled in the art. For example, an EMI absorber according to the present disclosure may be formed from a plastic material that is then coated with an EMI absorbing material. Alternatively, the EMI absorber may be formed from a material including EMI absorbing particles contained within or embedded in the material of the absorber.

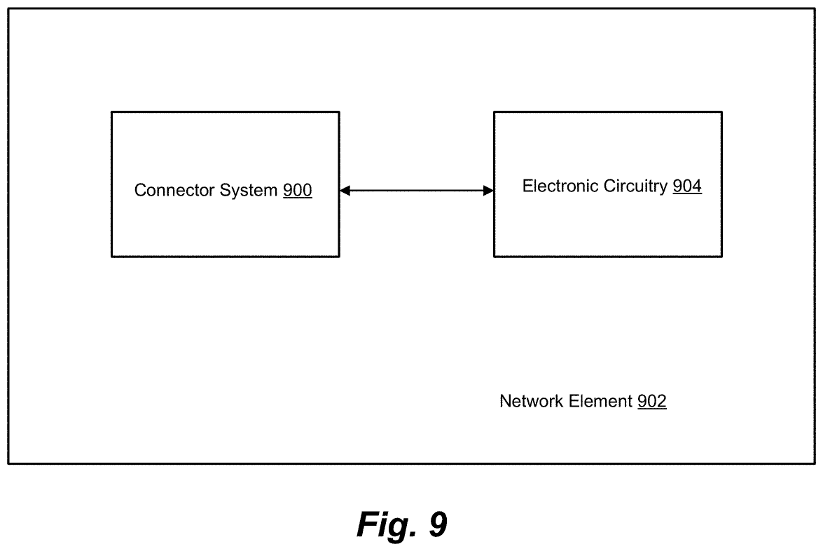

FIG. 9 is a functional block diagram of a connector system 900 in a network element 902 according to another embodiment of the present disclosure. The connector system 900 may include any one more or more of the connector systems 100-800 described above with reference to FIGS. 1-8. Electronic circuitry 904 in the network element 902 is coupled to the connector system 900. The electronic circuitry 904 includes electronic hardware, software, firmware, or a combination thereof, and may also include optical communication components, to implement the required functionality of the network element 902. In embodiments, the network element 902 is a network switch or router.

In further embodiments, the electronic connector may be other types of electronic connectors, and embodiments are not limited to electronic connectors that are coupled to a printed circuit board or other substrate. For example, in some embodiments the electronic connector may be a cable connector with the EMI absorber proximate the cable connector. The cable connector in such embodiments may be an RF connector, an I/O connector, and so on.

### Additional Examples

Each of the following non-limiting examples may stand on its own, or may be combined in various permutations or combinations with one or more of the other examples.

Example 1 is an electronic system, comprising: an electronic connector configured to be coupled to a printed circuit board, the electronic connector including a coupling port configured to receive a connector of a connector module; a connector cage configured to attach to the printed circuit board, the connector cage including an input port configured to receive the connector module and configured to guide the connector of the connector module into the coupling port of the electronic connector; and an electromagnetic interference (EMI) absorber at least partially covering the electronic connector, the electromagnetic absorber positioned between the electronic connector and the connector cage.

Example 2 is the subject matter of Example 1, wherein the electronic connector includes a top surface and a plurality of side surfaces over the printed circuit board, and wherein the EMI absorber at least partially covers one or more of the top surface and plurality of side surfaces.

Example 3 is the subject matter of Example 1, wherein the electronic connector includes a top surface and a plurality of side surfaces over the printed circuit board, and wherein the EMI absorber covers the top surface and the plurality of side surfaces.

Example 4 is the subject matter of Example 1, wherein the electronic connector includes a base attached to the printed circuit board and a coupling projection including the coupling port, and wherein the wherein the EMI absorber surrounds at least a portion of the coupling projection.

Example 5 is the subject matter of Example 1, wherein a layer of adhesive attaches the EMI absorber to one of the electronic connector and the connector cage.

Example 6 is the subject matter of Example 1, wherein the electronic connector comprises a surface mount technology (SMT) connector.

Example 7 is the subject matter of Example 1, wherein the electronic connector and connector cage form one of an Octal Small Formfactor Pluggable (OSFP) connector and a Quad Small Form Factor Pluggable Double Density (QSFP-DD) connector.

Example 8 is the subject matter of Example 1, wherein the connector module comprises an optical transceiver.

Example 9 is a network element, comprising: electronic circuitry; and a connector system coupled to the electronic circuitry, the connector system including: an electronic connector configured to be coupled to a printed circuit board, the electronic connector including a coupling port configured to receive a connector of an optical transceiver; a connector cage configured to attach to the printed circuit board, the connector cage including an input port configured to receive the optical transceiver and configured to guide the connector of the optical transceiver into the coupling port of the electronic connector; and an electromagnetic interference (EMI) absorber at least partially covering the electronic connector, the electromagnetic absorber positioned between the electronic connector and the connector cage.

Example 10 is the subject matter of Example 9, wherein the optical transceiver comprises a 400G optical transceiver.

Example 11 is a system, comprising: an electronic connector configured to be coupled to a connector module; and an electromagnetic interference (EMI) absorber proximate to and at least partially surrounding the electronic connector.

Example 12 is the subject matter of Example 11, wherein the EMI absorber is attached to the electronic connector.

Example 13 is the subject matter of Example 12, wherein a layer of adhesive attaches the EMI absorber to the electronic connector.

Example 14 is the subject matter of Example 11, wherein the electronic connector includes a plurality of surfaces, and wherein the EMI absorber at least partially covers at least some of the plurality of surfaces.

Example 15 is the subject matter of Example 11, wherein the electronic connector includes a top surface and a plurality of side surfaces, and wherein the EMI absorber at least partially covers at least one or more of the surfaces.

Example 16 is the subject matter of Example 11, wherein the electronic connector comprises a surface mount technology (SMT) connector.

Example 17 is the subject matter of Example 11, wherein the electronic connector includes a coupling projection including a coupling port, and where the EMI absorber is configured to slide onto and cover at least a portion of the coupling projection.

Example 18 is the subject matter of Example 11, wherein the EMI absorber comprises a top cover and a side cover attached at one end to the side cover, the side cover extending orthogonal to the top cover.

Example 19 is the subject matter of Example 11, wherein the EMI absorber comprises: a top cover including a higher segment and a lower segment; and a plurality of side walls attached to the higher and lower segments of the top cover.

Example 20 is the subject matter of Example 11, wherein the EMI absorber comprises at least one wall coupled to define an aperture on the interior of the at least one wall, the aperture configured to receive a coupling projection of the electronic connector.

The various features and processes described above may be used independently of one another or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

In the figures, the sizes and relative positions of elements in the drawings are not necessarily drawn to scale. For example, the shapes of various elements and angles may not be drawn to scale, and some of these elements may have been arbitrarily enlarged and positioned to improve drawing legibility. Further, some of the elements in the figures may have different shapes than the particular shapes of the elements as drawn in the figures.

What is claimed is:

1. An electronic system, comprising:
an electronic connector configured to be coupled to a printed circuit board, the electronic connector including a coupling port configured to receive a connector of a connector module;
a connector cage configured to attach to the printed circuit board, the connector cage including an input port configured to receive the connector module and configured to guide the connector of the connector module into the coupling port of the electronic connector; and
an electromagnetic interference (EMI) absorber at least partially covering the electronic connector, the electromagnetic absorber positioned between the electronic connector and the connector cage.

2. The electronic system of claim 1, wherein the electronic connector includes a top surface and a plurality of side surfaces over the printed circuit board, and wherein the EMI absorber at least partially covers one or more of the top surface and plurality of side surfaces.

3. The electronic system of claim 1, wherein the electronic connector includes a top surface and a plurality of side surfaces over the printed circuit board, and wherein the EMI absorber covers the top surface and the plurality of side surfaces.

4. The electronic system of claim 1, wherein the electronic connector includes a base attached to the printed circuit board and a coupling projection including the coupling port, and wherein the wherein the EMI absorber surrounds at least a portion of the coupling projection.

5. The electronic system of claim 1, wherein a layer of adhesive attaches the EMI absorber to one of the electronic connector and the connector cage.

6. The electronic system of claim 1, wherein the electronic connector comprises a surface mount technology (SMT) connector.

7. The electronic system of claim 1, wherein the electronic connector and connector cage form one of an Octal Small Formfactor Pluggable (OSFP) connector and a Quad Small Form Factor Pluggable Double Density (QSFP-DD) connector.

8. The electronic system of claim 1, wherein the connector module comprises an optical transceiver.

9. A network element, comprising:
electronic circuitry; and
a connector system coupled to the electronic circuitry, the connector system including:
an electronic connector configured to be coupled to a printed circuit board, the electronic connector including a coupling port configured to receive a connector of an optical transceiver;
a connector cage configured to attach to the printed circuit board, the connector cage including an input port configured to receive the optical transceiver and configured to guide the connector of the optical transceiver into the coupling port of the electronic connector; and
an electromagnetic interference (EMI) absorber at least partially covering the electronic connector, the electromagnetic absorber positioned between the electronic connector and the connector cage.

10. The network element of claim 9, wherein the optical transceiver comprises a 400G optical transceiver.

11. A system, comprising:
an electronic connector configured to be coupled to a connector module; and
an electromagnetic interference (EMI) absorber proximate to and at least partially surrounding the electronic connector.

12. The system of claim 11, wherein the EMI absorber is attached to the electronic connector.

13. The system of claim 12, wherein a layer of adhesive attaches the EMI absorber to the electronic connector.

14. The system of claim 11, wherein the electronic connector includes a plurality of surfaces, and wherein the EMI absorber at least partially covers at least some of the plurality of surfaces.

15. The system of claim 11, wherein the electronic connector includes a top surface and a plurality of side surfaces, and wherein the EMI absorber at least partially covers at least one or more of the surfaces.

16. The system of claim 11, wherein the electronic connector comprises one of a surface mount technology (SMT) connector and a cable connector.

17. The system of claim 11, wherein the electronic connector includes a coupling projection including a coupling port, and where the EMI absorber is configured to slide onto and cover at least a portion of the coupling projection.

18. The system of claim 11, wherein the EMI absorber comprises a top cover and a side cover attached at one end to the side cover, the side cover extending orthogonal to the top cover.

19. The system of claim 11, wherein the EMI absorber comprises:
a top cover including a higher segment and a lower segment; and
a plurality of side walls attached to the higher and lower segments of the top cover.

20. The system of claim 11, wherein the EMI absorber comprises at least one wall coupled to define an aperture on the interior of the at least one wall, the aperture configured to receive a coupling projection of the electronic connector.
